(19) United States
(12) Patent Application Publication
(10) Pub. No.: US 2025/0305231 A1
(43) Pub. Date: Oct. 2, 2025

(54) ARCHITECTED POROUS ARTIFICIAL REEFS

(71) Applicant: Massachusetts Institute of Technology, Cambridge, MA (US)

(72) Inventors: Michael S. Triantafyllou, Belmont, MA (US); Edvard Ronglan, Oslo (NO); Alfonso Parra Rubio, Somerville, MA (US); Alexis Oliveira da Silva, Paris (FR); Dixia Fan, Hangzhou (CN); Jeffrey Gair, Abingdon, MD (US); Patritsia Stathatou, Boston, MA (US); Carolina Bastidas, Belmont, MA (US); Jose del Aguila Ferrandis, Cambridge, MA (US); Erik Strand, Somerville, MA (US); Neil Gershenfeld, Cambridge, MA (US)

(73) Assignee: Massachusetts Institute of Technology, Cambridge, MA (US)

(21) Appl. No.: 19/091,233

(22) Filed: Mar. 26, 2025

Related U.S. Application Data
(60) Provisional application No. 63/570,008, filed on Mar. 26, 2024.

(51) Int. Cl. E02B 3/04; A01K 61/73

(52) U.S. Cl. CPC E02B 3/046; A01K 61/73

(57) ABSTRACT

Architected artificial reefs including modules of optimally arranged and sized multiple porous cylindrical bodies achieve an unprecedented wave energy dissipation rate, quantified through an equivalent drag coefficient of the order of 20, providing coastal protection against storms using a fraction of the material required in conventional artificial reefs. Selected porosity and selected material for the bodies within each reef module preserves the capacity for high drag coefficient, while offering the added advantages of ensuring a shelter to marine life, as well as making the building of the reefs in the field modular and efficient. Optimization of the dimensions and location of the multiple cylinders allow targeted design to fit the specific wave characteristics and bottom topography of the location to be protected. Architected artificial reefs with multiple porous and non-porous cylinders with overall diameters comparable to the wave height lead to high drag coefficients.

### CROSS-REFERENCE TO RELATED APPLICATION

This application claims the benefit of priority of U.S. provisional application No. 63/570,008, filed Mar. 26, 2024, the contents of which are herein incorporated by reference.

### STATEMENT OF GOVERNMENT SUPPORT

This invention was made with government support under HR0011-22-1-0002 awarded by the Defense Advanced Research Projects Agency. The government has certain rights in the invention.

### BACKGROUND OF THE INVENTION

The present invention relates to artificial reefs and, more particularly, to architected porous artificial reefs.

Coastal erosion is a rapidly growing threat to both the natural environment and the 600 million people living in low elevation coastal zones around the world. The loss of land and habitat, as well as the deterioration of infrastructure and economic assets, are just a few of the many challenges that follow. These challenges have been further intensified by climate change through rising sea levels, more frequent high-tide flooding, and powerful storm surges. As a result, without coastal protection or adaptation measures, a mean Representative Concentration Pathway, 8.5 W/m² (RCP8.5) scenario could result in an increase in the global land area, population, and assets at risk of flooding by 48%, 52%, and 46%, respectively by 2100. The pressing need for effective coastal defense strategies that can protect our coastlines and communities has therefore never been more urgent.

Coastal defense strategies to mitigate flooding and erosion have historically relied upon the implementation of hard engineering structures such as bulkheads, seawalls, breakwaters, tetrapods, gabions, and groins. While these interventions can effectively reduce the impact of wave forces, they often come at a significant cost and can result in adverse wave reflection. Furthermore, such measures are constructed with little regard for the ecological requirements and functions of marine ecosystems, thereby impeding the natural replenishment of sediment and potentially exacerbating the risk of erosion and flooding in other regions.

Conversely, coral reefs in nature have shown to attenuate up to 97% of wave energy serving as a unique natural coastal protection structure along nearly 71,000 km of coastline worldwide, while also contributing positively to the marine ecosystem. However, 60% of the world's reefs are under immediate and direct threat from one or more local stressors, including rising ocean temperatures, overfishing and coastal development. If no measures to reduce stressors are taken, 90 percent of coral reefs are expected to be in danger by 2030, and nearly all of them by 2050. Other nature-based solutions, such as mangrove planting, offshore reefs, seagrasses, and sills, offer promising alternatives, but may not fully meet the objectives of wave dissipation.

In an effort to emulate the energy dissipation (Ed) and marine habitat enhancement benefits of natural reefs, artificial reefs are being used. Artificial reefs typically either consist of sunken structures such as oil and gas platforms, ships, and port structures, or they are special structures made of concrete, metal, plastic, tires, or rocks. As a result of their high complexity in terms of volume, area, and vertical relief, these structures have proven to support comparable levels of fish density, biomass, species richness, and diversity as natural reefs. However, due to variability in planning and research, it was found that only 50 percent of artificial reef structures met their objectives in 2001. Moreover, even when constructed successfully, artificial reef structures often have low wave energy dissipation efficiency, requiring the construction of unnecessarily massive structures to meet wave energy dissipation requirements.

As can be seen, there is a need for an artificial reef that can provide storm energy dissipation comparable to a natural coral reef and can provide shelter to marine life.

### SUMMARY OF THE INVENTION

In one aspect of the present invention, an artificial reef comprises modules having a cross-sectional diameter determined according to a predicted height of a wave for a selected location of application.

The artificial reef may exhibit any combination of the following characteristics: a drag coefficient of at least 2 when using a projected area, and preferably on the order of 20 or higher when referenced to an equivalent diameter as defined herein; a ratio of an amplitude of the wave to the cross-sectional diameter greater than 0.2; a ratio of an amplitude of the wave to the cross-sectional diameter greater than 0.25; a ratio of an amplitude of the wave to the cross-sectional diameter less than 0.5; a ratio of an amplitude of the wave to the cross-sectional diameter less than 0.4; and effectiveness to reduce energy of the wave proportional to a frequency of the wave.

The modules may have any combination of the following characteristics: an overall height determined according to predicted water depth of the selected location of application; substantially cylindrical elements oriented vertically with respect to a water body floor; truncated pyramidal elements, having a base width and a top width, joined to a floor having a thickness; a central component encircled by four pillars, with a distance between a longitudinal axis of the central component and a longitudinal axis of each of the four pillars being x units along a first axis and y units, greater than x, along a second axis normal to the first axis. Each module may have a plurality of voxels. The central component may have an elliptical cross section with a first length and each of the four pillars may have a second length.

A biohydrodynamic solution employing architected artificial reefs that bridge the gap between hard and soft coastal protection structures provides high wave energy dissipation while preserving the marine ecosystem. A structural design method leverages Bayesian optimization and computational fluid dynamics (CFD) to maximize the drag coefficient of an architected structure comprising multiple porous vertical cylinders with a cross-sectional diameter of the order of the wave height, combined with a smaller scale porosity. To ensure biocompatibility, the structures are generally porous, providing not only efficient energy dissipation but also shelter for ocean species. One of the most effective designs exhibited a surprisingly high ability to dissipate wave energy, confirming an unprecedented drag coefficient of the order of 20, which implies that energy dissipation can be achieved with structures that contain a small fraction of the material contained in conventional artificial reefs.

These and other features, aspects and advantages of the present invention will become better understood with reference to the following drawings, description, and claims.

### BRIEF DESCRIPTION OF THE DRAWINGS

FIG. 1A is a sectional view of a baseline reef module according to an embodiment of the present invention;

FIG. 1B is a perspective view thereof;

FIG. 1C is a chart illustrating experimental drag coefficient results therefor;

FIG. 2 is a schematic view illustrating parameters for a truncated pyramid voxel building block of a reef module according to embodiments of the present invention;

FIG. 3 is a schematic view of a towing tank for experimental wave generation;

FIG. 4A is a schematic view of parameters for optimization of a reef model according to an embodiment of the present invention;

FIG. 4B is a diagram of drag coefficients associated with the reef model of FIG. 4A, plotted against two of the parameters (xₚ and yₚ);

FIG. 4C is a chart illustrating the experimental drag coefficient for the best-performing configuration of the model of FIG. 4A;

FIG. 4D is a schematic view of parameters for optimization of a reef model according to another embodiment of the present invention;

FIG. 4E is a diagram of resulting drag coefficients plotted against two of the parameters (xₚ and yₚ);

FIG. 4F is a chart illustrating the experimental drag coefficient for the best-performing configuration of the model of FIG. 4D;

FIGS. 5A, 5B, and 5C depict velocity and vorticity of the flow around a reef module according to the model of FIG. 4A at three successive times;

FIGS. 6A, 6B, and 6C depict velocity and vorticity of nearly symmetric flow around a reef module according to the model of FIG. 4D at three successive times;

FIGS. 7A, 7B, and 7C depict vorticity and velocity of non-symmetric flow around a reef module according to the model of FIG. 4D at three successive times;

FIG. 8 is a chart illustrating Experimental drag coefficient for reef module according to the model of FIG. 4A, made from voxels; and

FIG. 9 is a chart illustrating Drag coefficient of reef modules according to the model of FIG. 4A obtained in waves, compared to the drag coefficient obtained when the modules undergo an oscillatory motion.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

An equivalent diameter (D_{eq}) is defined herein as the diameter of a circular cylinder with the same cross-sectional area as a reef module body.

The drag coefficient (CD) is a dimensionless quantity that characterizes the resistance of an object to a fluid flow. A higher drag coefficient indicates greater energy dissipation capability of the reef module when subjected to wave action.

Representative wave amplitude, as used herein, refers to a characteristic measure of wave height used for determining the appropriate dimensions of the artificial reef modules for a specific deployment location. For an ocean environment with variable wave conditions, the representative amplitude may be derived from statistical analysis of historical wave data and may correspond to half the average height of the highest one-third of waves, half the root-mean-square wave height, or another statistical measure that adequately represents the expected wave conditions during storm events at the selected location. This representative amplitude may be used to determine the optimal equivalent diameter of the reef modules to achieve the desired drag coefficient and energy dissipation performance.

The ratio of wave amplitude to equivalent diameter (A/Deq) is a dimensionless parameter that characterizes the relationship between the wave conditions and the reef module dimensions. In this context, ‘A’ represents the wave amplitude, defined as half the wave height from trough to crest.

Vortex pairs refer to two adjacent rotating fluid structures with opposite rotational directions (one clockwise and one counterclockwise) that form in the water flow around the reef modules. These vortex pairs interact to create strong jet-like flows in various directions, which dissipate wave energy. The formation and interaction of these vortex pairs contribute to the high drag coefficient and energy dissipation capabilities of the architected reef modules.

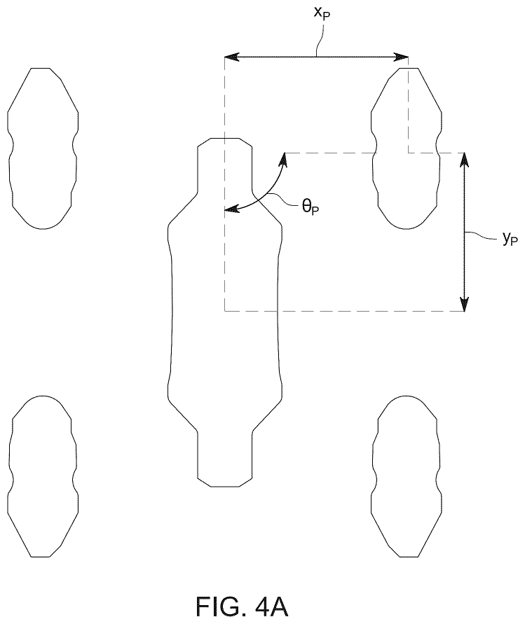

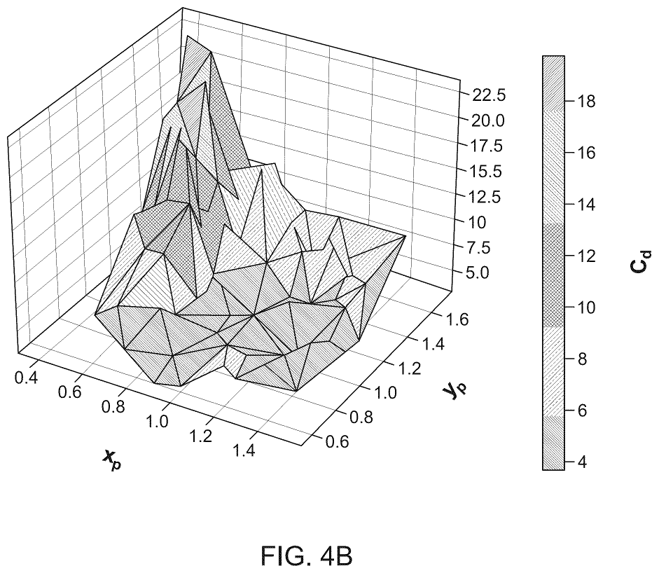

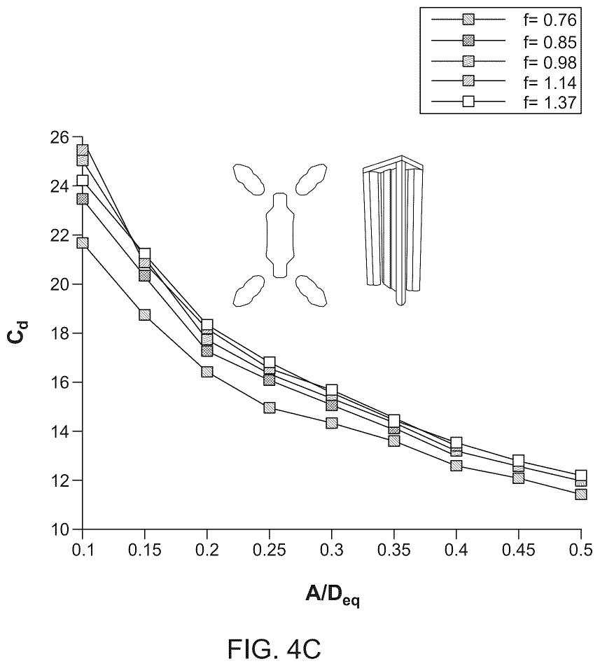

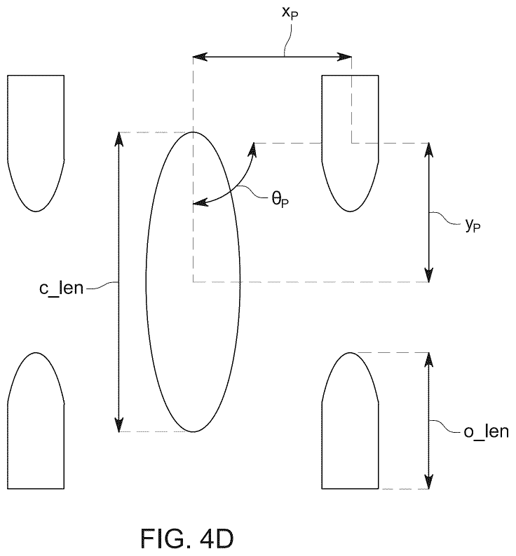

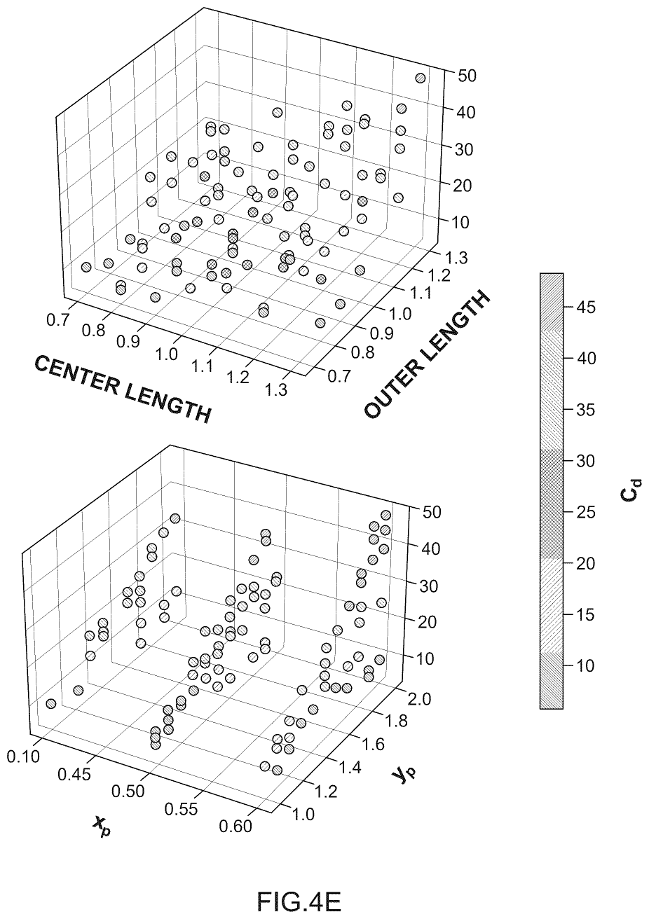

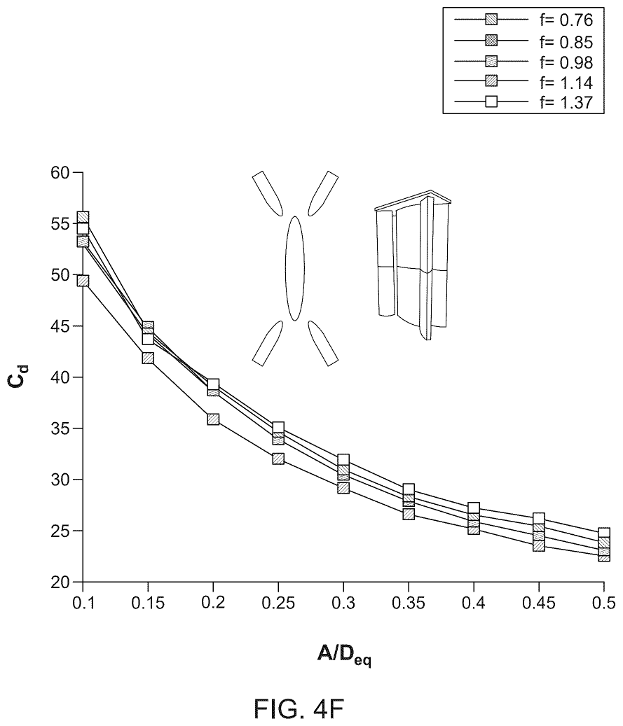

The geometric configuration of a reef module may be described using the following parameters. X-distance and y-distance (xp and yp) are each measured from the central axis of the central component to the central axis of each peripheral component. See FIG. 4A. Angular orientation (θp) refers to the rotational angle of the peripheral components around their z axis relative to the central component of the module and may be represented in degrees or radians. As shown in FIG. 4D, central length (c_len) refers to the length of a central component along the y axis and outer length (o_len) refers to the length of a peripheral component. These parameters determine the size and shape of flow channels between the components and the overall hydrodynamic behavior of the module.

As used herein, the term “voxel” refers to any of multiple discrete elements of a three-dimensional entity or body. A voxel may refer to a three-dimensional building element or unit cell that serves as the fundamental constructional component of the reef modules. Specifically, voxels are discrete volumetric elements with defined geometrical properties that, when assembled together according to a predetermined pattern, form the overall structure of the reef module or its components. In preferred embodiments, these voxels may take the form of truncated pyramids characterized by a base width, top width, and height, which can be joined to a floor element of specified thickness. The modular nature of these voxels enables efficient fabrication, transportation, and assembly of the reef modules while simultaneously creating the porosity for both wave energy dissipation and marine habitat functionality. The size, shape, arrangement, and spacing of these voxels can be varied to achieve specific hydrodynamic properties and structural characteristics in the final reef module.

Porosity, as used herein, refers to the presence of open spaces or voids within the reef module structure, including overall gaps between voxels. Porosity can be characterized as the ratio of void volume to the total volume of the reef module. The porosity may be implemented through gaps between voxels in a voxel-based construction, through the use of multiple smaller diameter parallel cylindrical elements arranged at specified distances from each other, and/or through other architectured void spaces within the module components. This controlled porosity maintains the module's wave energy dissipation capabilities while creating protective spaces that allow marine life to shelter and thrive within the reef structure.

Terms not otherwise defined herein generally have meanings as understood by those having skill in the fluid dynamics art. For example, terms may be interpreted to have the meanings used, for example, in Reeve, D., Chadwick, A. & Fleming, C. Coastal Engineering: Processes, Theory and Design Practice (CRC Press, 2018), 3 edn.; Goda, Y. Random Seas and Design of Maritime Structures, vol. 15 (World Scientific, 2000), 2 edn.; Dean, R. G. & Dalrymple, R. A. Water Wave Mechanics for Engineers and Scientists, vol. 2 (World Scientific, 1991); Faltinsen, O.

M. Sea Loads on Ships and Offshore Structures (Cambridge University Press, 1990); and Wright, L. D., Wu, W., Morris, J. (2019). Coastal Erosion and Land Loss: Causes and Impacts. In: Wright, L., Nichols, C. (eds) Tomorrow's Coasts: Complex and Impermanent. Coastal Research Library, vol 27. Springer, Cham. https://doi.org/10.1007/978-3-319-75453-6_9.

Broadly, one embodiment of the present invention is an architected artificial reef for coastal protection against wave action and shelter for marine life.

Natural reefs can protect coasts against intense wave storms and provide shelter to abundant marine life. The architected reefs presented herein are designed for intense energy dissipation achieved through the formation of multiple large-scale vortices that combine in pairs to induce strong multi-directional jets that can convert wave energy to support turbulent flow. While this is desirable for coastal protection, it is not conducive to sheltering marine life within the architected reefs made of monolithic bodies due to the very strong unsteady flow patterns that form. To emulate the sheltering action of natural reefs, we introduced controlled porosity in the constituent building blocks, which was found to preserve their capability to dissipate wave energy, while providing protected spaces for marine life to shelter and grow. Indeed, the flow inside the porous modules is weak and characterized by the formation of small-scale vortices associated with wakes that are known to even have beneficial effects to the swimming effort of swimming fish (Liao et al 2003). The use of porosity architectures with fractal structure, as studied for example in Bai et al (2015) would provide a multi-scale flow structure that is closer to that of natural reefs.

Architected artificial reefs according to the present disclosure, comprising modules of optimally arranged and sized multiple porous cylindrical bodies, achieve an unprecedented wave energy dissipation rate, quantified through an equivalent drag coefficient of the order of 20, providing coastal protection against storms using a fraction of the material required in conventional artificial reefs. Properly selected porosity for the bodies within each reef module preserves the capacity for high drag coefficient, while offering the added advantages of ensuring a shelter to marine life, as well as making the building of the reefs in the field modular and efficient.

The hydrodynamic mechanism providing large drag coefficients in architected reefs is shown to derive from the formation of large-scale vortices between pairs of adjacent cylinders that generate intense jet-like flows acting at different directions. We find a high sensitivity of the drag coefficient to parametric variation of the dimensions and location of the multiple cylinders, allowing for a targeted design through optimization to fit the specific wave characteristics and bottom topography of the location to be protected.

Installing architected artificial reefs further offshore, before the wave breaking zone, provides a means for significantly reducing wave setup and overtopping, and hence sediment transport. As a result, we envision that these architected reefs are suitable for locations offering an appropriate bottom topography, viz. a sufficient depth combined with a mild slope near the shore such that the reef can be installed before wave breaking is initiated.

In a preliminary assessment of the materials necessary to build the architected reefs, we successfully considered five commercially available concrete materials that were found to offer (a) sufficient strength and (b) chloride impermeability, while (c) their biological and environmental impacts, in terms of leaching of lead, changes in carbonate values, and effects on survival of early life stages of marine species are minimal.

Architected cellular materials effectively mitigate the challenges mentioned above due to their lightweight and high load-bearing capacity. They can also be discretely assembled, facilitating the construction of macroscopic structures using a building block strategy. Moreover, the inherent porosity of these macroscopic forms provides shelter for marine life. Considering these factors, the ultimate artificial reef was chosen as a discretely assembled architected structure. This involved employing concrete unit cells to form the calculated optimized shape. The repeating unit cell, known as a voxel, was designed as a truncated pyramid. This geometry enables straightforward assembly along Cartesian directions while also facilitating a straightforward casting approach.

The reef energy dissipation was maximized using Bayesian optimization and employing CFD simulations and towing tank experiments conducted on modules of the reef. A model of an artificial reef structure having two staggered rows of reef modules was tested in harmonic waves at model scale in the Massachusetts Institute of Technology (MIT) Towing Tank and confirmed an order of magnitude increase in dissipation of wave energy.

To reduce the computational effort, we targeted the optimization of reef architecture subject to sinusoidal waves, while varying the amplitude and frequency to assess their impact. We found weak dependence of the drag coefficient, which directly controls the amount of dissipated energy, on the frequency, but strong dependence on the ratio of the wave amplitude A to equivalent diameter of the structure Dq, viz. Drag Coefficient, or Coefficient of Drag (CD) depends on the inverse of A/Dq. Hence the sizing of an architected reef depends on the characteristics of the waves in a storm and more specifically on the significant wave height (SWH), providing the proper scaling parameters. In some embodiments, multi-layer reefs comprising rows of modules of different equivalent diameter are capable of strong energy dissipation for a range of storms with a range of significant wave heights.

We showed that the very high drag coefficients achieved through optimization are applicable to oscillatory flows. For a steady oncoming flow around a stationary structure there is no mechanism for drag enhancement because no added mass energy is available for conversion. In addition, we find high sensitivity of the process of vortex pairing to the timing of flow reversal; this implies that a steady flow superimposed on the oscillatory flow would also degrade the drag amplification process. Hence, the results obtained here are applicable to wave storm energy attenuation, without simultaneous strong tidal surges.

Architected artificial reefs were developed, optimized, and tested, according to the following method.

A baseline reef module shape, with a corresponding parametric CAD model, was optimized utilizing CFD simulations and Bayesian optimization. Optimization utilized a CAD parametric model adaptable by leveraging the Solidworks® Application Programming Interface (API) in Python. The results of the CFD were verified with experiments in the MIT Sea Grant towing tank.

The optimization step utilized an algorithm that selects the parameters to be tested at each iteration, a parametric model that generates a CAD model with the specified parameters, and a CFD program that evaluates the energy dissipation performance of the model and sends the result back to the optimization algorithm. This loop was repeated until the energy dissipation was maximized.

To reduce the computational and experimental effort, the effect of forces due to harmonic waves having frequency ω and amplitude A acting on an architected reef module was assessed. The dissipation of wave energy by the module is due to drag forces; hence the drag term of Morison's equation was utilized to estimate the energy dissipated over one time period for each module as:

$${E}_{d} = {\int }_{0}^{T} {\int }_{- H}^{- q} 1 / 2 ρ {C}_{D} {D}_{eq} u \vert u \vert udzdt$$

where q is the average distance from the water surface to the top of the reef module, H is the water depth, ρ is the water density, D_{eq} is the equivalent diameter of a module, which is defined to be the diameter of a circular cylinder with the same area as the reef module, T=2π/ω is the wave period, CD is the drag coefficient, and u(z, t) is the velocity of the wave at depth z and time t. The term “D_{eq}” is used herein interchangeably with the terms D_{q} and Dₘ.

There is a difference between the action of waves, which induce an amplitude of fluid oscillation that decays exponentially with depth, while the velocity includes vertical as well as horizontal components; but as shown herein the physical mechanisms are similar, while the optimization effort is decreased substantially. CFD simulations, in combination with experimental testing in the MIT Sea Grant 10-meter towing tank, imposed horizontal harmonic oscillatory motions to a small-scale model of a reef module, to represent the effect of water waves:

$${C}_{d} = \frac{\frac{1}{T} {\int }_{0}^{T} F ( t ) u ( t ) dt}{\frac{2}{3 π} ρ {D}_{eq} {L ( A ω )}^{3}}$$

where x is the position, A is the amplitude and w is the oscillating frequency. The amplitude of motion was scaled by the ratio of the model length scale to the full-size length scale, and the frequency by the square root of the inverse of the same ratio, i.e. scaling the wavelength and using the dispersion relation. For example, for a wave of amplitude A=3 m and frequency ω=0.72 rad/s, or f=0.114 Hz, a reef module with equivalent diameter D_{eq}=6 m may be targeted, so that A/D_{eq}≈0.5. Hence, a reef model with equivalent diameter Dₘ=7 cm would require an oscillation of A=3.5 cm and a frequency of f=1.14 Hz. Since the energy dissipation is proportional to the drag coefficient, the subsequent expression, derived for harmonic oscillation, was used for the purpose of optimization:

$$x = A sin ( ω t )$$

where L is the length of the module.

Bayesian optimization was used to optimize the parameters of the reef module. Bayesian optimization is a widely used approach for maximizing (or minimizing) an objective function, f, with expensive and noisy evaluations. It can be expressed as:

$${x}^{*} = {arg max}_{x ∈ X} f ( x )$$

where x represents data points in the search space of interest, X. The approach employs a surrogate model to represent the objective function, and to inform the selection of new samples to evaluate. The point to sample is determined by maximizing an acquisition function that evaluates each candidate point with a trade-off between exploration and exploitation.

Gaussian process regression (GPR) was chosen as the surrogate model in these examples because the estimated prediction uncertainty is useful when selecting the next sample, and it has been successful in relevant research. See Rasmussen, C. E. Gaussian Processes for Machine Learning (The MIT Press, 2005). Prior to starting Bayesian optimization, initial data points were generated to fit the GPR model using Halton sampling that uses deterministic Halton sequences to generate points that appear random and uniformly distributed over the domain. This low-discrepancy method is often used for Monte Carlo simulations and provides a good basis for the GPR model. The GPR model calculates the probability distribution over all admissible functions that fit the points sampled from the objective function. It uses a mean function to represent the underlying trend of the data, and a kernel to represent the covariance between data points. The mathematical expression is given as

$$p ( f , x ) = N ( f \vert μ , K )$$

where N is the standard normal distribution, μ is the mean function, and K is the covariance kernel matrix.

The expected improvement method (El) proposed by Mockus was used as the acquisition function. The reason for choosing El as acquisition function is that it has performed well both in theory and practice. This method chooses the candidate point that has the maximum expected improvement compared to the best point already evaluated:

$$EI ( x ) = ( μ - {f}^{*} ) Φ ( γ ) + σφ ( γ )$$

where Φ is the Cumulative Distribution Function (CDF) and φ is the Probability Density Function (PDF) of the standard normal distribution, f* is the current best evaluation, σ is the standard deviation and γ is given by

$$γ = \frac{μ - f *}{σ}$$

The CFD simulation program disclosed herein builds on the Boundary Data Immersion Method (BDIM) developed by Weymouth and Yue, which has demonstrated success in subsequent studies. This is an immersed boundary method and simulates the fluid-body interaction on a fixed Cartesian-grid. The program also uses implicit large-eddy simulation (iLES) to simulate turbulent flows, which is especially suited for modeling large-scale turbulent eddies. The program is therefore a good fit for this problem since the drag forces on the reef modules are dominated by large eddy formation, while not having to fit a body-fitted grid allows for efficient optimization.

The computational domain employed was body-centered and had dimensions of (14, 6, 1) Wbase. Here, Wbase corresponds to the width of the baseline module. Periodic boundary conditions were applied in the spanwise direction, and symmetric boundary conditions were used in the cross-spanwise direction. The number of grid points in each dimension were (576, 320, 64), with a spacing of Δx/Wbase=1/64 near the body and geometric expansion in the far field.

To determine the appropriate domain size, a sensitivity analysis was conducted using the baseline module and a close body resolution of Δx/Wbase=1/64. The analysis showed that the difference between the chosen domain size of (14, 6, 1) Wbase and the largest domain size of (26, 18, 1) Wbase was 5.7%, which was considered acceptable for optimization purposes. Similarly, the close body grid spacing was selected based on a sensitivity analysis using the same baseline reef module and a domain size of (14, 6, 1) Wbase. The analysis showed that the difference between the chosen resolution of Δx/Wbase=1/64 and the finest resolution of Δx/Wbase=1/128 was negligible.

In addition to measuring the wave amplitude before and after the artificial reef, we calculated an approximate drag coefficient for the reef modules in waves. This involved utilizing the energy dissipation (Ed) equation for a single reef module, discussed above, and incorporating the expressions for horizontal velocity and the dispersion relation for deep water waves. This resulted in the following expression:

$${E}_{d} = \frac{4}{9} g ρ {C}_{D} {D}_{eq} {A}^{3}$$

We then multiplied this expression with the number of rows, N, and equated it to the energy flux dissipated by one row of reef modules inline with the wave propagation:

$${d}_{\%} {E}_{f} {TW}_{tot} = {NE}_{d}$$

where d % represents the percentage of wave energy reduced by the artificial reef measured in experiments, Ef is the wave energy flux, T is the wave period and Wtot is the combined width of the reef module and the distance between the modules in a row (Wtot=W+ys). Solving for the drag coefficient, we obtain:

$${C}_{D} = d \% \frac{18 π}{16} \frac{{gW}_{tot}}{N {ω}^{2} {D}_{eq} A}$$

An insight into the source of drag or thrust increase due to unsteady motion can be found in Weymouth & Triantafyllou (2012, 2013), where it was shown that an accelerating body undergoing shape change can convert added mass energy into energy contained in large eddies, that can then result in significant thrust or drag. As outlined in Krueger & Gharib (2003) moving vortices carry added mass energy; hence the conversion of the reef added mass energy to that contained in the forming pairs of vortices can provide an estimate of the structure and circulation of the eddies. Similar concepts apply to fish fast-starts, where it is shown that through body flexing the fish engages added mass energy that is then used to be converted into large vortices that provide axial forces to accelerate rapidly (Gazzola et al 2012, Triantafyllou et al 2016). This contrasts with a different mechanism employed by a fast-starting octopus where added mass energy is recaptured (Weymouth & Triantafyllou 2013). These cases involve conversion of added mass energy to either pressure gradients, or the formation of large-scale vortices, which can be manipulated to provide forces of desired direction and amplitude.

Let us assume that the added mass energy is converted entirely into energy contained in the large-scale vortices (idealized total conversion), hence creating drag; the details of the mechanism through which this is achieved are discussed above. To make the problem simple, we assume that the reef is a cylindrical body with an elliptical cross section with minor semi-axis a and major semi-axis b placed in an unsteady stream of velocity u=uo sin (ωt), where uo=Aω, with A the amplitude of oscillatory fluid motion, with the large semi-axis facing the flow. We define an equivalent diameter D_{eq} as that of a cylinder with the same area as the ellipse, viz D_{eq}=2 (ab), where a is the length of a first semi-axis and b is the length of a second semi-axis. The drag force may then be written over a cycle of period T:

$${m}_{a} {\int }_{0}^{T} \vert \frac{du}{dt} u \vert dt = \frac{1}{2} ρ {C}_{D} {D}_{eq} {\int }_{0}^{T} {u}^{2} \vert u \vert dt$$

where mₐ is the added mass and C_{D} the drag coefficient. The absolute value within the integral is needed since the added mass energy is not recovered by the body. Taking mₐ≈πb², we find that:

$${C}_{D} = \frac{3 π}{8} \frac{b}{a} \frac{1}{( A / {D}_{eq} )}$$

Hence, we calculate, for example, that for b/a=5, the drag coefficient for A/D_{eq}=0.25 is C_{D}=24, and for A/D_{eq}=0.5 it is C_{D}=12. Given that the elliptical shape is a substantial simplification of the reef shape, and the assumed ratio b/a is very approximate, these values are in good agreement with the values we find herein; also, the trend of the drag coefficient depending on the inverse of the amplitude is fully explained.

For oscillating bodies, such as flexibly mounted bluff bodies in oncoming crossflow, the drag coefficient can be amplified by a factor of 3 or more, as the vibration of oscillation increases. This amplification is a strong function of the reduced frequency f*=f U/D, as well as the reduced amplitude A*=A/D, where f is the frequency of oscillation, A the amplitude of oscillation, U the stream velocity, and D the projected diameter. Hence it is possible to achieve higher coefficients in unsteady flows, although the mechanism of amplification, which is frequency- and amplitude-dependent, has not been explored.

As shown above, the pressure gradients induced by the oncoming waves cause the formation of multiple vortices, which form pairs inducing strong jets moving in various directions that can enhance wave energy dissipation. The conversion of mass energy added into vortex-formation can explain the large drag coefficients.

### Experimental Setup

The experimental work was conducted in two different specialized towing tanks. The first tank located at MIT Sea Grant has an overall length of 10 m and was used to study the forces on the reef module forced to oscillate in quiescent water. The second, 30 m long towing tank, was used to study the full artificial reef in waves. The setup of each is described in detail below.

### 10-Meter Towing Tank for Oscillating Motion

The experiments involving sinusoidal motion were conducted at the MIT Sea Grant towing tank, which measures 10 m in length and 1 m in width and height. The tank is equipped with a carriage system that can move in four degrees of freedom: two in the x-direction (steady forward, plus oscillatory forward), one in the y-direction, and one allowing for rotation about the z-axis. This setup enabled use of a sinusoidal motion to investigate different angles of attack for the reef modules. The parameters used for these experiments are listed in Table 1, where the amplitude and frequency are based on real world values and scaled as described above.

TABLE 1
Parameters for evaluating the drag coefficient
of reef modules with oscillating motion.

| Parameter | Value | | Description |
|---|---|---|---|
| h | 0.32 | m | reef module height |
| D_{eq} | 0.07 | m | reef module equivalent diameter |
| H | 0.9 | m | water level in tank |

| | | |
|---|---|---|
| A/D_{eq} | 0.1-0.5 | amplitude relative to equivalent diameter |
| f | 0.76 Hz-1.37 Hz | oscillation frequency |

### 30-Meter Towing Tank for Wave Generation

The towing tank used for testing the full artificial reef in waves is 30 m long, 2.6 m wide, and 1.2 m deep. It features a wave generator that generates waves of controlled height and frequency, as well as a beach that absorbs the wave energy at the opposite end of the tank. The parametric values used for these experiments are given in Table 2. These values were scaled based on actual storm conditions, CFD simulations, and results from the experiments conducted with the oscillating motion described herein. To create the artificial reef, we stacked reef modules in two rows, with the modules in each row placed in a staggered position to maximize obstruction to the flow induced by waves. To fit within the tank, this resulted in the first row having one more module than the second.

TABLE 2
Parameters for testing in towing tank with waves.

| Parameter | Value | Description |
|---|---|---|
| H | 1.15 m | water level in tank |
| A | 0.01 m-0.05 m | wave amplitude |
| f | 0.8 Hz, 1 Hz and 1.2 Hz | wave frequency |
| h | 0.78 m | reef module height |
| D_{eq} | 0.12 m | equivalent diameter |
| W | 0.24 m | width of reef module |
| yₛ | 0.18 m | spacing between units in a row |
| xₛ | 0.35 m | spacing between rows |
| N_{y} | 6 and 5 (first | number of reef modules in a row |
| | and second row) | |
| Nₓ | 2 | number of rows |

The outcomes of two successive optimization stages of the shape of reef modules, the results of porous reef modules, the experimental results obtained from tests of a reef model in oncoming water waves, and an explanation of the physical mechanism causing the high drag coefficients measured and the implications for an artificial reef, are discussed below.

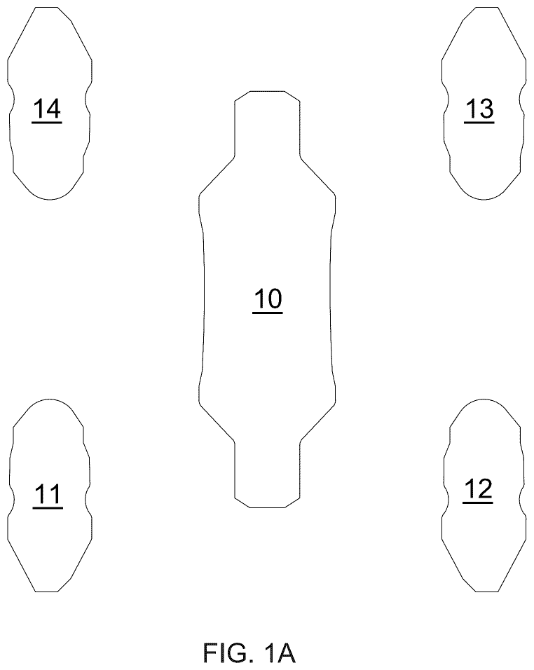

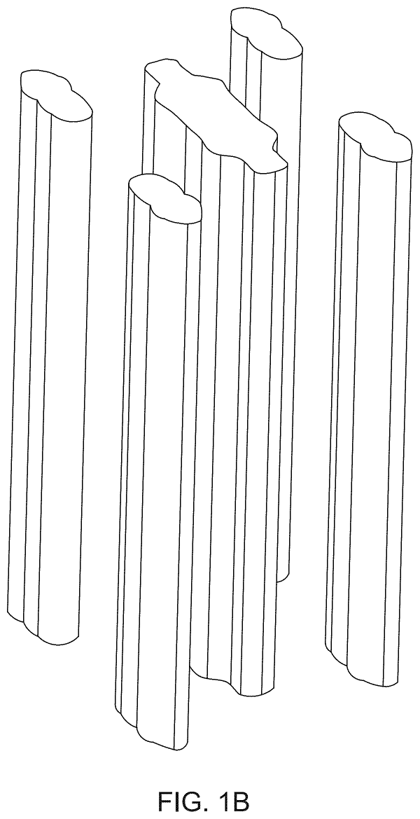

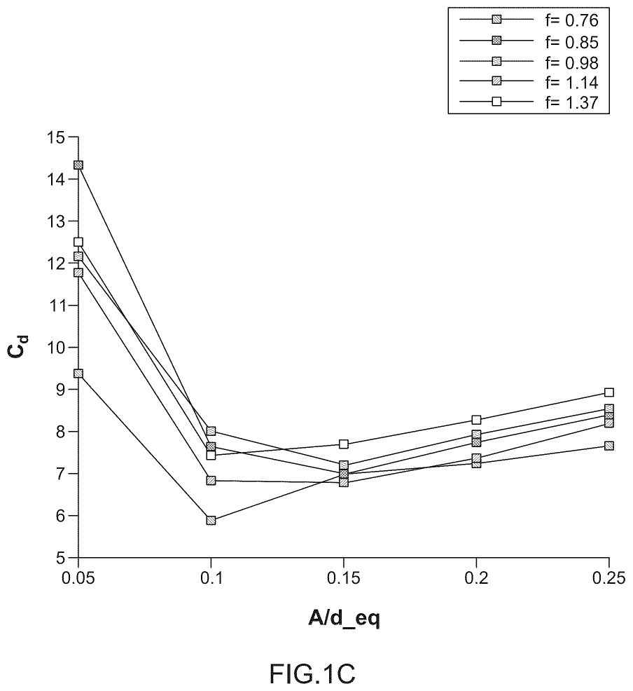

Referring to FIGS. 1A-1C, 2, 3, 4A-4F, 5A-5C, 6A-6C, 7A-7C, and 8-9, FIGS. 1A and 1B illustrate a baseline reef module used in an optimization process, the module having a central column 10 and four peripheral columns 11, 12, 13, 14. The baseline module was based on a previous study showing that the drag coefficients of a multi-body design were an order of magnitude higher than conventional methods would suggest. To confirm that the baseline module had similarly high drag coefficients, experimental testing was conducted according to the method discussed above. The results, shown in FIG. 1C, exhibited high drag coefficients that were consistent with the previous findings.

The parameters chosen for optimization were f=0.76 Hz and A/D_{eq}=0.15, leading to a Reynolds number of Re=3510 when using the maximum oscillating velocity and equivalent diameter of the reef module. The reason for choosing f=0.76 Hz was that the drag coefficient for different frequencies does not change substantially around this frequency value, as shown in FIGS. 1A, 1B, and 1C, and hence the lowest relevant frequency was chosen to limit the required resolution of the CFD simulations. An amplitude of A/D_{eq}=0.15 was chosen as it was found to be high enough to generate fully developed flow. The drag coefficient at different amplitudes is also highly correlated, as discussed above, so an optimization at A/D_{eq} =0.15 optimizes the drag at higher/lower amplitudes as well.

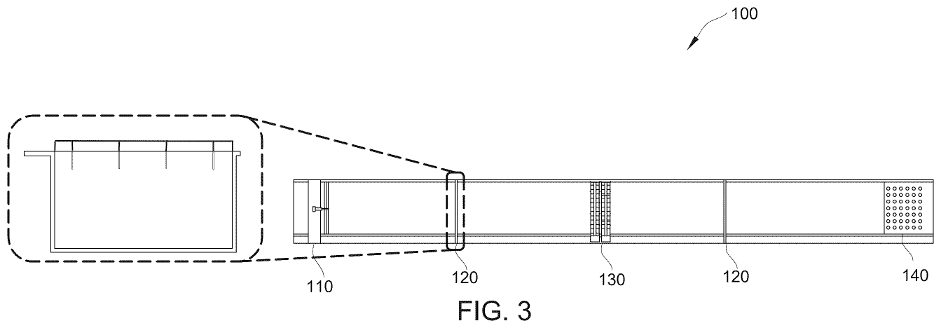

The reef modules were built out of porous building blocks to make them easier to fabricate and potentially more biocompatible. The resulting porous reef modules were also tested in the MIT Sea Grant towing tank 100 (see FIG. 3).

Natural reefs comprise intricate structures with multiple stochastic cavities that lead to high energy dissipation while providing a habitat for marine life. In contrast, as shown in FIG. 1A, the optimized artificial reef modules have a constant cross-section, monolithically extruded. While this design is beneficial for vortex generation and energy dissipation, it lacks the ability to adequately shelter marine life. Additionally, the manufacturing and underwater installation of such volumetric and solid structures would be highly complex and expensive. To address both issues, porosity was introduced to emulate the function of natural reefs and hence study their hydrodynamic properties.

Two-dimensional porosity is introduced by constructing the bodies from multiple smaller diameter parallel cylinders at an adjustable distance from each other; and then we introduce three-dimensional porosity as explained herein. Porosity is expected to potentially shelter marine life creating a habitat emulating the properties of natural reefs.

To validate the performance equivalence of a porous artificial reef to a non-porous artificial reef, comparative experiments were conducted. As a first step, porous models made from elongated steel rods were tested to evaluate the effect of porosity without the influence of non-uniformity or sharp edges on flow. Using rods as building blocks also offers insights into the hydrodynamics of natural reefs made of cylindrical components.

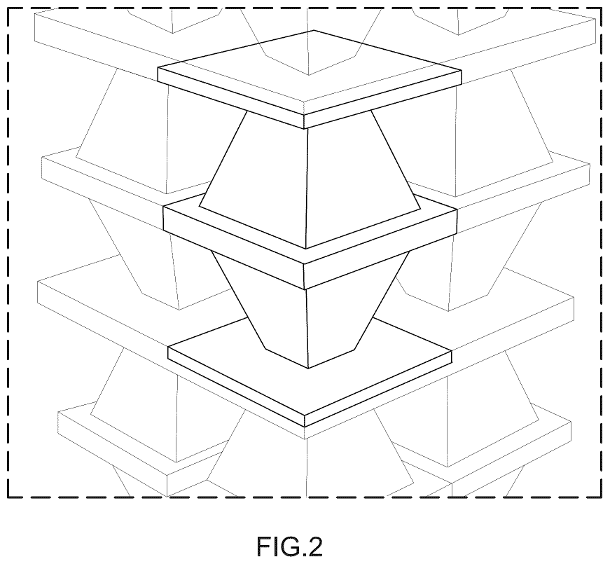

Once we validated that porous models made from steel rods could perform as solid ones, we generated models of a voxel-based porous artificial reef. The models were fabricated using Selective Laser Sintering (SLS) Nylon printing, utilizing a Formlabs Fuse, which enabled the production of pieces with a resolution of 100 microns. Given a certain optimized shape, we populated it with various sizes of truncated pyramids, with the associated parameters detailed in FIG. 2, wherein the part names of the models correspond to the parameters that FIG. 2 shows. A cell with base square size (measured across the base [i.e., the widest of two ends] of a pyramidal unit) of 4 mm, with a top square size (measured across the top [i.e., the narrowest of two ends] of a pyramidal unit) of 1.5 mm, a cell-to-cell separation (measured at the bases of adjacent pyramidal units) of 0.8 mm and a floor thickness (measured as the height of a square block having a first surface and a second surface, having the base of a first pyramidal unit abutting the first surface and the base of a second pyramidal unit abutting the second surface, the height being the distance between the first surface and the second surface) of 0.5 mm was referred to as B40T15C08F05.

The findings herein are consistent with previous research, such as the work on unbounded flow around a localized circular array of multiple cylinders by Nicolle et al., where it was shown that, for low porosity, porous cylinders maintain a similar flow structure as solid cylinders that includes large scale vortex formation, with the only difference that a wider shedding angle is found in the detaching shear layer.

The wave elevation before and after the reef 130 was measured using eight probes 120, and their placements were based on previous studies. Specifically, four probes 120 were positioned 5.9 m from the paddle or wavemaker 110 and 6.6 m in front of the first row of the reef 130, while four probes 120 were placed 5.4 m after the second row of the reef 130. At both locations, the probes 120 were placed normal to the tank 100 side as illustrated in the enlarged view in FIG. 3. To prevent interference from wave reflection, the wave elevation before the reef 130 was measured until the waves reached the reef 130, and the wave elevation after the reef 130 was measured until the waves reached the beach 140. An overview of the experimental setup is given in FIG. 3.

The optimization was conducted in two major stages, using two different baseline modules and sets of parameters. The parametric models used, and the optimization results, are illustrated in FIGS. 4A, 4B, 4C, 4D, 4E, and 4F. The exact parametric values are presented in Table 3, and the measured drag coefficients of the five best-performing modules from both iterations are given in Table 4.

The model parameters included in the first round of optimization were the location (x- and y-coordinate) and the angle (θ) of the four outer bodies relative to the center body of the baseline module presented above. The parameters are illustrated in FIG. 4A and the specific values for the parametric space are given in Table 3. A total of 71 configurations were simulated in CFD guided by Halton sampling and Bayesian optimization, and the resulting drag coefficients are plotted in FIG. 4B for different values of xp and yp, where xp is the length along the x axis from the center of the central body to the center of an outer body; yp is the length along the y axis from the center of the central body to the center of an outer body; and θ is the angle between the vertical axis of the central body and the horizontal axis of the outer body. The figure reveals that low values of xp and high values of yp are beneficial; this is further confirmed in the top 5 configurations with the highest drag coefficient presented in Table 4.

TABLE 3
Parametric spaces for both optimization stages

| | Values | Values |
|---|---|---|
| Parameter | First iteration | Second iteration |
| xₚ | 0.4, 0.5, . . . , 1.4, 1.5 | 0.4, 0.5, 0.6 |
| yₚ | 0.6, 0.7, . . . , 1.6, 1.7 | 1.0, 1.1, . . . , 1.9, 2.0 |
| θₚ | 1/6, 2/6, . . . , 10/6, 11/6 | 3/6, 4/6, 5/6 |
| c_lenₚ | — | 0.7, 0.8, . . . , 1.2, 1.3 |
| o_lenₚ | — | 0.7, 0.8, . . . , 1.2, 1.3 |

To verify these computational results, the best-performing module (xp=0.6, yp=1.4 and θp=3/6) was tested experimentally in the MIT Sea Grant 10-meter towing tank. The resulting experimental drag coefficient with the corresponding cross section and experimental model are presented in FIG. 4C. The results show that the drag coefficient is approximately twice that of the baseline module above. The values of the parameters were given relative to their respective baseline reef module, with the following absolute parameter values: x=43.7 mm, y=38.8 mm, θ=90 deg., c_len=83.66 mm and o_len=37.8 mm, where x, y and θ were common for both iterations and c_len and o_len were only used for the second stage.

TABLE 4
Resulting drag coefficients for the five best-performing
configurations of both optimization stages

| | Parameters | | | | | |
|---|---|---|---|---|---|---|
| | xₚ | yₚ | θₚ | c_lenₚ | o_lenₚ | C_{D} |
| First iteration | 0.6 | 1.4 | 3/6 | — | — | 21.75 |
| | 0.5 | 1.7 | 5/6 | — | — | 20.96 |
| | 0.5 | 1.6 | 4/6 | — | — | 20.93 |
| | 0.5 | 1.5 | 4/6 | — | — | 20.51 |
| | 0.6 | 1.3 | 3/6 | — | — | 20.48 |
| Second | 0.6 | 2.0 | 4/6 | 1.3 | 1.3 | 48.21 |
| iteration | 0.6 | 1.9 | 4/6 | 1.3 | 1.3 | 47.98 |
| | 0.6 | 1.9 | 4/6 | 1.3 | 1.2 | 44.53 |
| | 0.6 | 2.0 | 4/6 | 1.3 | 1.2 | 44.45 |
| | 0.5 | 2.0 | 4/6 | 1.3 | 1.3 | 43.39 |

Using the trends established, and to further enhance the performance of the reef design used in the first optimization stage, the shapes of the individual bodies were modified. Initially, the objective was to generate new shapes that would simplify the manufacturing process, while preserving the high drag coefficients. After experimenting with various shapes, we found the cross section shown in FIG. 4D to perform well for the stated purposes. We then decided to further expand the parametric space by including the lengths of the central and outer bodies as additional parameters. The width of the bodies was also changed as a function of the length, while keeping the cross-sectional area of the bodies constant. FIG. 4D illustrates the modified baseline module with the associated parameters, while the parametric space is provided in Table 3. After evaluating 96 configurations with Halton sampling and Bayesian optimization, the best-performing configurations are given in Table 4. The results show that reef modules with elongated individual bodies and high values of yₚ have the highest drag coefficients, as shown in the plots of FIG. 4E. The experimentally measured drag coefficients of the best-performing configuration (xp=0.6, yp=2.0, θp=4/6, c_len=1.3 and o_len=1.3), given in FIG. 4F, confirm the findings from the optimization and show an even larger drag coefficient that is approximately twice that of the best-performing shape of the first optimization stage.

To minimize cost, and given the similar forces measured in porous modules, non-porous modules were utilized to build the artificial reef for the experiments in waves. At the time of wave tank testing, the second optimization stage was not yet completed so the best-performing module in the first optimization stage was used, illustrated in FIG. 4C, as basis. The artificial reef underwent testing using various wave amplitudes and frequencies, as given in Table 2, above, and a summary of the results is presented in Table 5.

TABLE 5
Wave height measured before and after the reef, and
the associated reduction in wave energy for the
artificial reef tested in the MIT towing tank.

| | Wave height | Wave height | Energy |
|---|---|---|---|
| Frequency (Hz) | before reef (mm) | after reef (mm) | reduction |
| 0.8 | 22.6 | 20.4 | 18.1% |
| 0.8 | 50.6 | 42.0 | 31.2% |
| 0.8 | 78.4 | 63.2 | 35.1% |
| 1.0 | 16.2 | 14.1 | 24.5% |
| 1.0 | 55.8 | 40.8 | 46.7% |
| 1.0 | 93.6 | 63.5 | 54.0% |
| 1.2 | 21.3 | 12.9 | 63.0% |
| 1.2 | 62.0 | 33.9 | 70.2% |
| 1.2 | 96.5 | 51.1 | 72.0% |

The wave height on both sides of the reef is given as an average of the wave height measured by 4 probes.

The optimized modules from the second optimization stage exhibit stronger vortices and at least two more sideways-moving vortex pairs per half cycle when comparing to the first stage. This results in a far more energized flow, which leads to a significantly increased drag coefficient. In addition to the increased channeling of the flow, through intense jet formation caused by this shape of the module, sharp corners added to the outer bodies of the module increased the drag coefficient compared to the Bayesian Optimization (BOP)-inspired shapes in the first optimization iteration. This effect is mainly due to enhanced vortex shedding, as demonstrated by the higher drag coefficient of diagonal square cylinders versus circular cylinders, at low Keulegan-Carpenter (KC) numbers.

Flow visualizations for the best-performing modules from both optimization stages illustrate the mechanisms that lead to high drag coefficients.

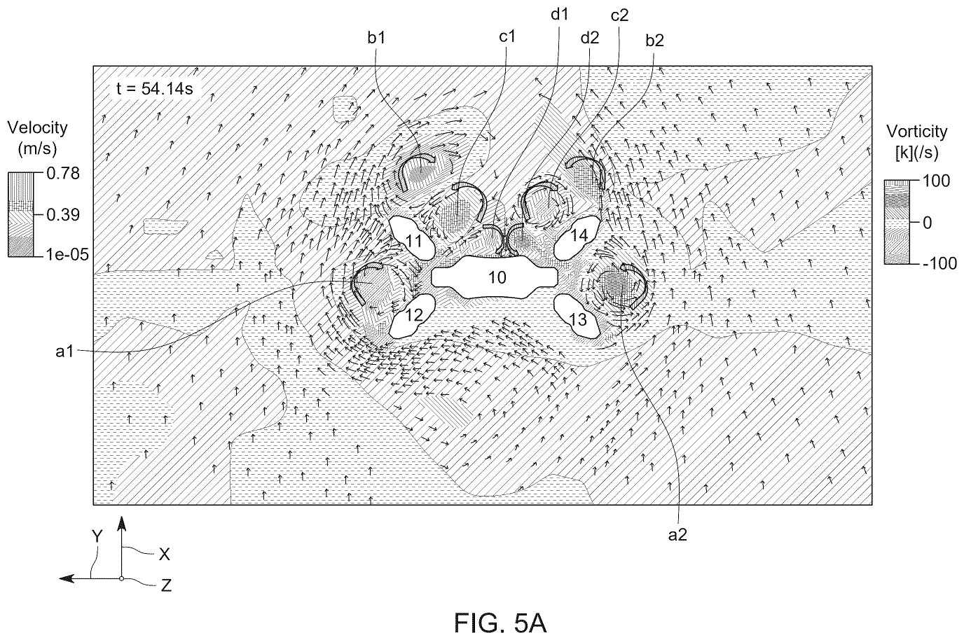

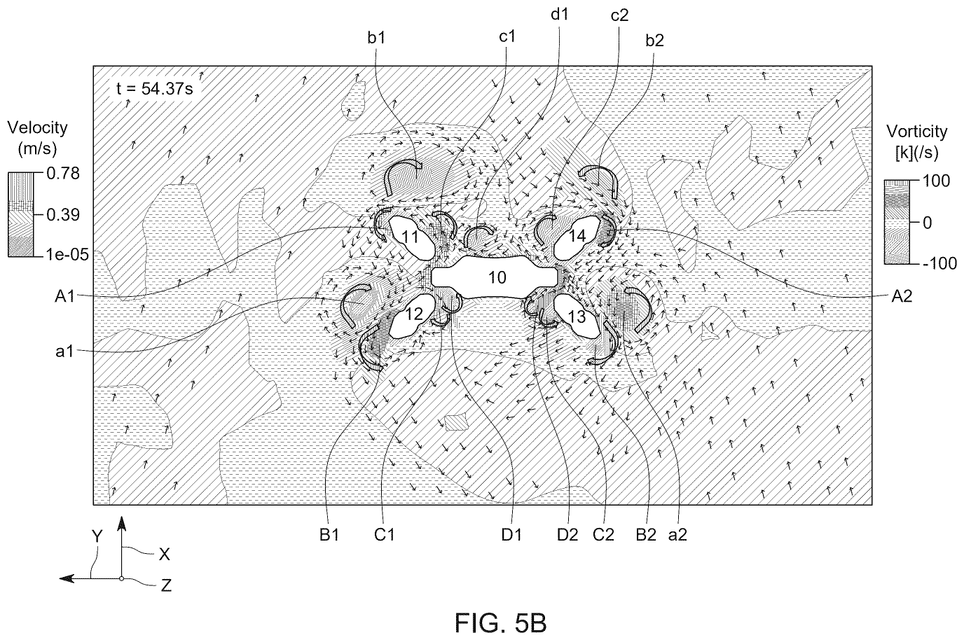

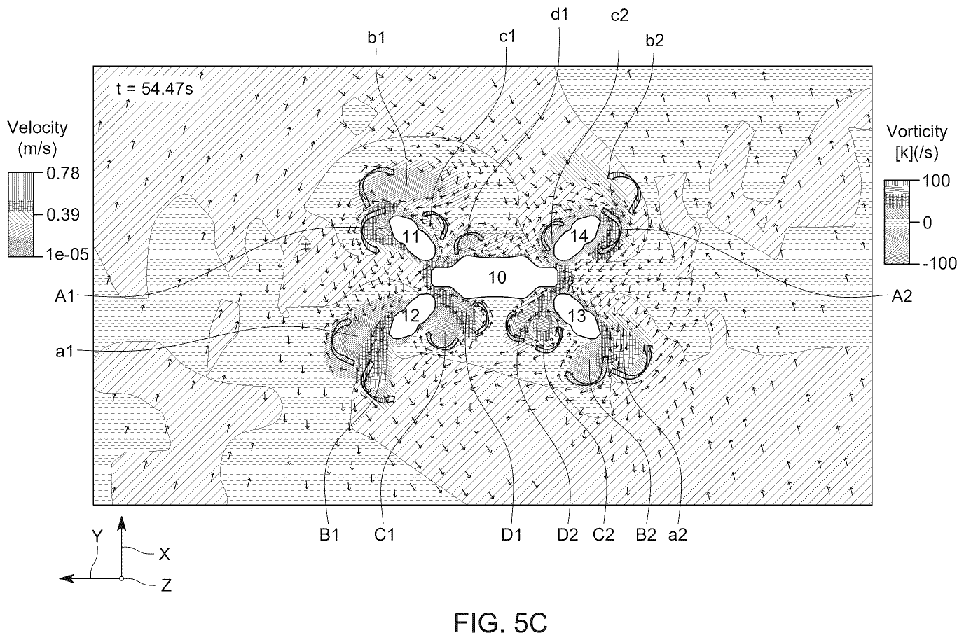

Velocity and vorticity illustrations, naming of vortices, and CFD simulations are shown in FIGS. 5A, 5B, and 5C, with roman numerals added to denote vortices in the subsequent half cycle. FIGS. 5A, 5B, and 5C depict the flow evolution for a module with parameters xp=0.6, yp=1.4 and θp=3/6, which was the module emerging as the best-performing in the first optimization stage. For reference, the central body is labeled 10 and the four outer bodies are labeled 11, 12, 13, and 14. Lowercase letters are used to represent vortices from the previous half cycle, uppercase letters denote forming vortices, and roman numbers are used for the next half cycle. The vorticity is illustrated with intensity shading in the background, and the velocity is illustrated through flow vectors with associated intensity shading. Clockwise and counterclockwise arrows are also added to highlight individual vortices. The naming of the vortices is done using lowercase letters for those formed in the previous half cycle, and uppercase letters for those formed in the current half cycle. The numbers are odd for the left half and even for the right half of the flow. The simulations were done with f=0.76 Hz and A/D_{eq}=0.5 in Simcenter Star CCM+® computational fluid dynamics-based simulation software, resolving Detached Eddy Simulations with fully resolved boundary layers using Structural Simulation Toolkit (SST)-Menter k-ω turbulence model and a Convective Courant Number maintained below 1. Due to the left-right symmetry of the flow, only the vortices on the left side of the figures are detailed in this sequence. At time t=54.14 s in FIG. 5A, the evolution of vortices is shown at the end of the preceding half cycle, with the fluid moving from the bottom towards the top. Vortices are denoted as C (clockwise) or CC (counterclockwise). We identified four major vortices: a1 (C), b1 (C), c1 (CC), and d1 (C). In FIG. 5B at t=54.37 s, the flow has turned and induces a strong jet between bodies 11 and 10, which persists between bodies 12 and 10, and resulting in the formation of strong vortices C1 (C) and D1 (CC). Simultaneously, vortices A1 (CC) and B1 (CC) emerge from the left ends of bodies 11 and 12, respectively, where vortex B1 also interacts with vortex a1 from the preceding half cycle. At t=54.47 s, FIG. 5C shows the nearly complete evolution of the emerging vortices A1, B1, C1, and D1, which closely resembles the vortices found in FIG. 5A from the previous half-cycle, except that they are bottom-up mirror images. For example, the pair (C1, D1) is the upside-down image of pair (c1, d1).

FIGS. 5A, 5B, and 5C show that when comparing to the baseline module, the optimized module leads to more intense channeling of the flow and formation of significantly stronger pairs of opposite sign coherent vortices, resulting in strong jets. These effects are the reason for the drastic increase in drag coefficient. Such observations are also consistent with previous research in shapes having two cylinders, showing that circular cylinders in side-by-side configuration induce higher drag coefficients due to the pairing of two oppositely signed vortices, formed from the sides of the two adjacent cylinders, which produces a jet flow. Similar findings were also established in the work with multiple cylinders used in the offshore industry, showing the potential for much higher drag coefficients, as vortices from adjacent cylinders pair up forming jets in various locations and directions.

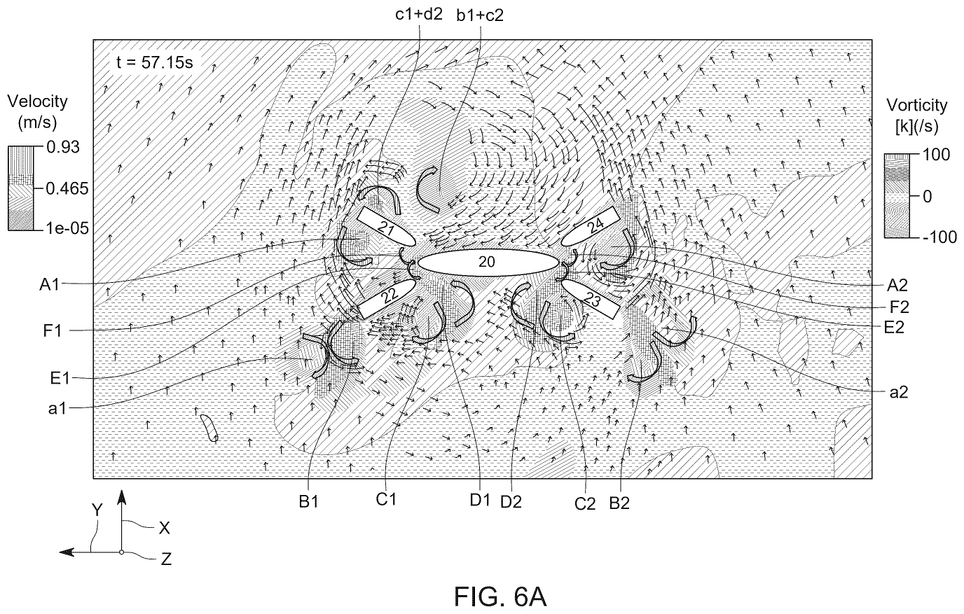

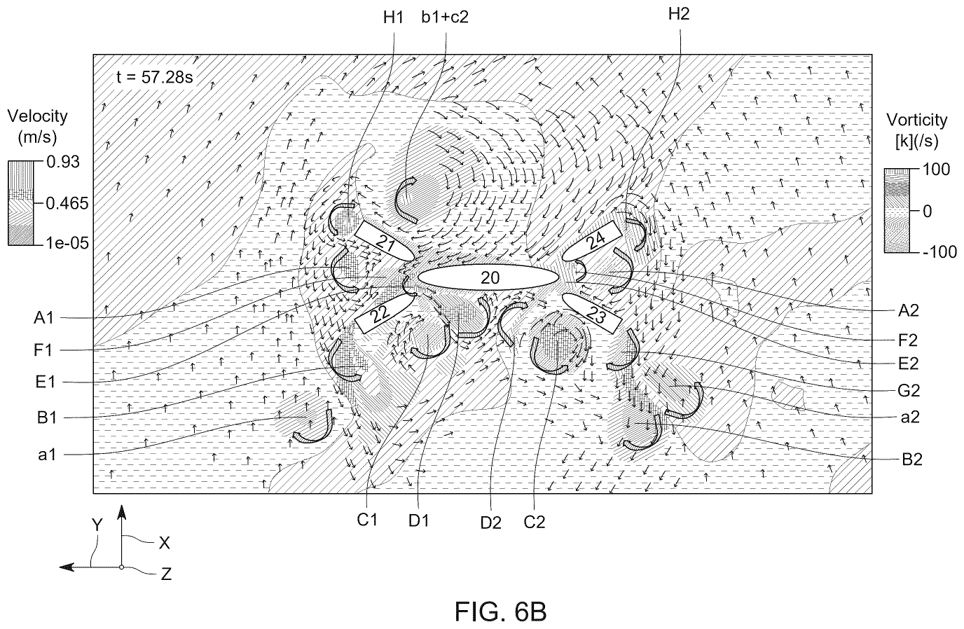

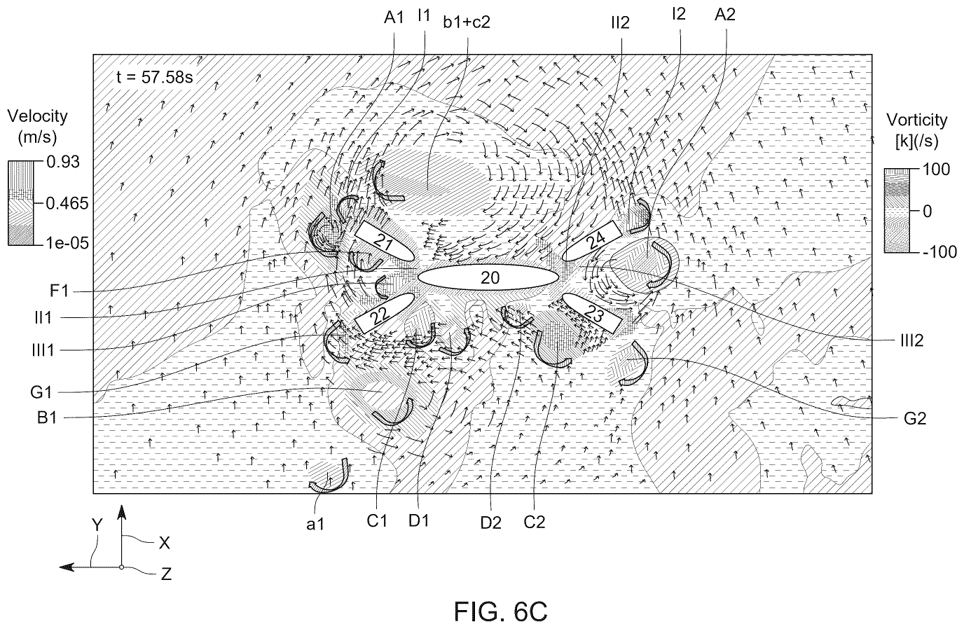

Velocity and vorticity illustrations, naming of vortices, and CFD simulations are shown in FIGS. 6A, 6B, and 6C. FIGS. 6A, 6B, 60, 7A, 7B, and 7C present the flow evolution for a module characterized by parameters xp=0.6, yp=2.0, θp=4/6, c_len=1.3 and o_len=1.3, which was the best-performing module in the second optimization stage. Since the flow illustrated in FIGS. 6A, 6B, and 6C is nearly left-right symmetric, details are only provided about the left half of the module. In FIG. 6A at time t=57.15 s, the flow moves from top to bottom, resulting in: a new vortex A1 (CC) from the left end of body 21; a new vortex B1 (CC) from the left end of body 22, accompanied by the vortex a1 (C) from the previous half cycle; a new pair of vortices between bodies 22 and 20, specifically C1 (C) and D1 (CC); and another pair of vortices between bodies 21 and 20, F1 (C) and E1 (CC). The pairs (C1, D1) and (F1, E1) induce intense jet flows, with a milder jet flow caused by the (a1, B1) pair. FIG. 6B depicts the evolution at t=57.28 s, where the pairs (C1, D1) and (F1, E1) have grown but continue to be fed by the flow. By FIG. 6C at t=57.58 s, the flow reverses and starts to move from bottom to top. A new vortex pair, (II1, III1), is forming between bodies 22 and 20, nearing body 21, and a new vortex 11 emerges from the left end of body 21.

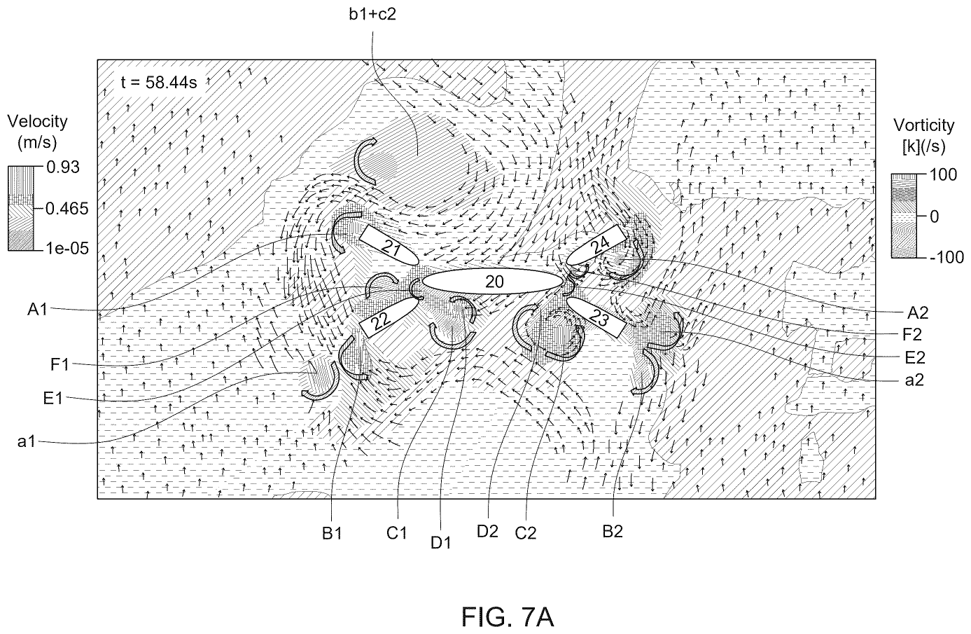

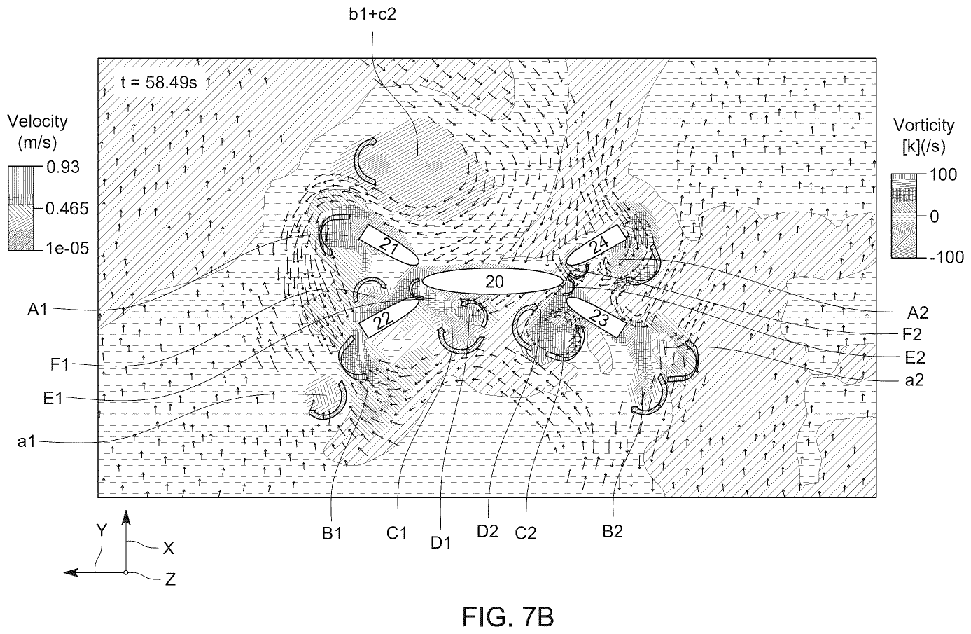

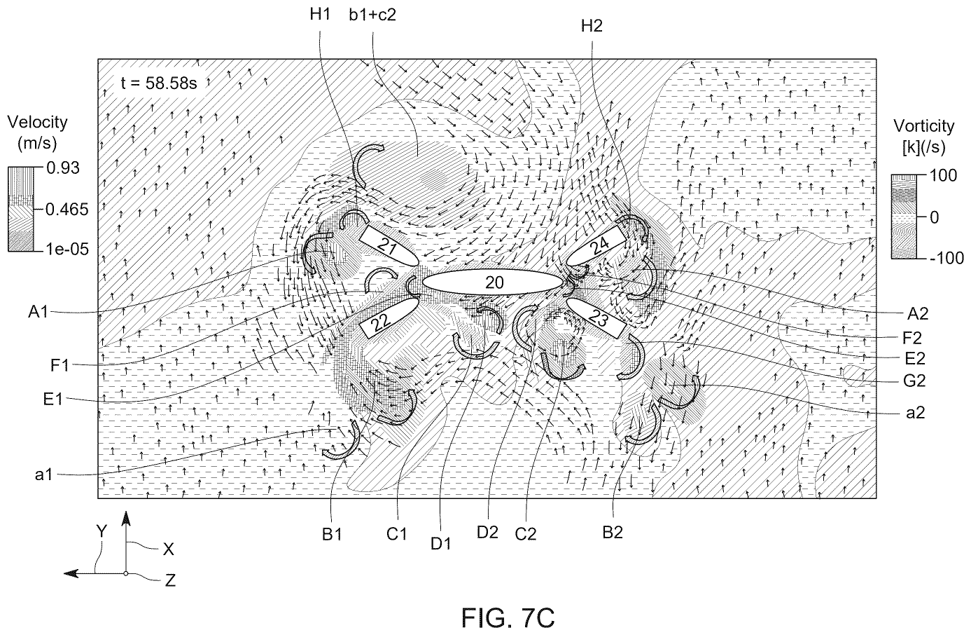

FIGS. 7A, 7B, and 7C show a sequence that is different than the previous two, because it is not left-right symmetric at any specific instant, although the overall symmetry of the flow evolution is preserved: when the flow reverses, the right side exhibits the same flow patterns as the left side did before the flow reversal occurred. FIG. 7A shows the flow at time t=58.44 s and with the flow from top to bottom, roughly the same patterns as in FIG. 6A. The main difference is that the vortex pairs (F1, E1) and (C1, D1) develop differently on the left side than their mirror images on the right side of the module. Indeed, (C1, D1) grows stronger than (D2, C2), and, especially, (F1, E1) is far stronger than (F2, E2). FIG. 7B (t=58.49 s) and 7C (t=58.58 s) show that the trend continues, resulting in the left half of the unsteady flow overwhelming the right side. Over the next half cycle, as the flow reverses, the exact opposite occurs, as the right side overwhelms the left side. This break in instantaneous left-right symmetry occurs randomly.

Table 6 compares the experimental drag coefficient of porous modules made from 3 mm steel rods placed at a distance equal to R/4, versus that of non-porous modules, at a frequency of f=0.98 Hz and an amplitude of A/D_{eq}=0.25. This was done with the baseline module and a module with parameters xp=0.6, yp=1.3, and θp=4/6, which had exhibited the best performance in the optimization up to the time of testing. Our results show that porous modules experience a similar amplification of drag coefficient as non-porous modules. Hence, for appropriate levels of porosity, the desired flow channeling and large eddy generation occurs for porous modules as well. In fact, for the porosity tested, the porous modules consistently exhibit a higher drag coefficient than non-porous modules.

TABLE 6
Experimental drag coefficient at A/D_{eq} = 0.25 and
f = 0.98 Hz for porous and non-porous modules

| | Drag coefficient | Drag coefficient |
|---|---|---|
| module | porous | non-porous |
| Baseline module | 13.6 | 8.2 |
| Optimized module | 21.2 | 15.5 |

The two modules used are (a) the baseline module and (b) an optimized module with xp=0.6, yp=1.3 and θp=4/6. The porous modules were made from steel rods with 3 mm diameter and R/4 clearance between adjacent rods.

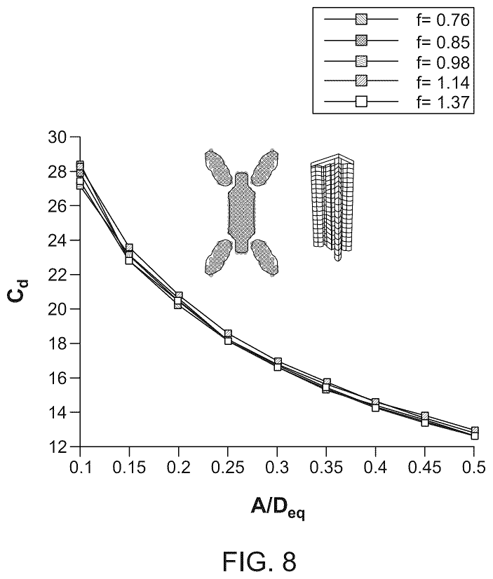

After confirming the properties of porosity using steel rods as building blocks, three-dimensional porosity was introduced by designing a module made from optimized modular voxel building blocks. The part number of the voxels used was B30T10C04F05. FIG. 8 provides the resulting drag coefficient together with an illustration of the experimental model. It is shown that the drag coefficient is close to that of the corresponding module made with rods, indicating that similar flow structures result from both types of porosity.

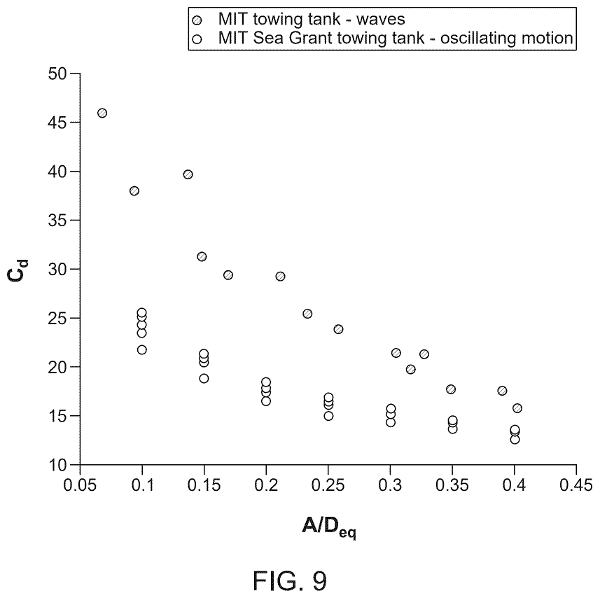

We compare the drag coefficient measured on reef modules in waves with the experimental results of modules undergoing oscillatory motion. As shown in FIG. 9, the drag coefficient in waves is significantly higher. The reason is that, in water waves, the amplitude of fluid motion decays exponentially with water depth; hence the amplitude of motion to diameter ratio diminishes with depth, which increases the drag coefficient as shown in FIGS. 4A, 4B, 4C, 4D, 4E, and 4F and discussed above, where it is shown that the drag coefficient is proportional to the inverse of the wave amplitude to diameter ratio. Since we employ the amplitude of motion at the water surface to compare with experimental results, the drag coefficient in waves is consistently higher. The trends, however, in terms of amplitude and frequency dependence remain the same.

The measured high drag coefficients are an order of magnitude higher than the typical drag coefficient in steady flow. For a stationary bluff body within steady flow, a typical drag coefficient is on the order of C_{D}≈1.0, based on the projected area in the direction of the flow. The coefficient is a function of several parameters, such as the geometry of the body, the presence of sharp edges, and the Reynolds number. The specific values range, again typically, from about 0.2 for three dimensional objects, to up to about 2.0 for two dimensional objects with sharp edges.

It should be understood, of course, that the foregoing relates to exemplary embodiments of the invention and that modifications may be made without departing from the spirit and scope of the invention as set forth in the following claims.

What is claimed is:

1. An artificial reef, comprising:
a plurality of modules, each of the plurality of modules comprising a central component and peripheral components arranged around the central component, each of the plurality of modules having an equivalent diameter determined according to a characteristic of at least one wave for a selected location of application, the characteristic selected from a predicted elevation or a representative amplitude;
wherein each of the peripheral components is positioned at a distance from the central component, the distance comprising an x-distance along a first axis and a y-distance along a second axis normal to the first axis
wherein the equivalent diameter is defined as a diameter of a circular cylinder that has an area equal to a cross-sectional area of one or more of the modules, not accounting for porosity; and
wherein for an ocean storm, the at least one wave is a plurality of waves and the representative amplitude is a root-mean-square of the predicted elevation.

2. The artificial reef of claim 1, wherein the modules have a height determined according to predicted water depth of the selected location.

3. The artificial reef of claim 2, wherein the modules have a height between 0.2 and 0.9 times the predicted water depth of the selected location.

4. The artificial reef of claim 1, wherein the central component and the peripheral components are cylindrical and are oriented vertically with respect to a water body floor.

5. The artificial reef of claim 1, wherein the modules have truncated pyramidal elements joined to a floor, wherein the truncated pyramidal elements each have a base width and a top width, and the floor has a thickness.

6. The artificial reef of claim 1, wherein the artificial reef exhibits a drag coefficient of at least 2 for a wave amplitude determined to be representative of the selected location.

7. The artificial reef of claim 6, wherein the drag coefficient is about 20 or higher.

8. The artificial reef of claim 1, wherein the y-distance is greater than the x-distance.

9. The artificial reef of claim 1, wherein the central component has an elliptical cross section with a first length and each of the peripheral components has a second length.

10. The artificial reef of claim 1, wherein a ratio of the representative amplitude of the plurality of waves to the equivalent diameter is greater than 0.2.

11. The artificial reef of claim 1, wherein a ratio of the representative amplitude of the plurality of waves to the equivalent diameter is greater than 0.25.

12. The artificial reef of claim 1, wherein a ratio of the representative amplitude of the plurality of waves to the equivalent diameter is less than 0.5.

13. The artificial reef of claim 1, wherein a ratio of the representative amplitude of the plurality of waves to the equivalent diameter is less than 0.4.

14. The artificial reef of claim 1, wherein each of the modules comprises a plurality of voxels.

15. The artificial reef of claim 1, wherein the modules are configured to generate vortex pairs that create flow jets in multiple directions to dissipate wave energy with a drag coefficient of at least 2 when using a projected area.

16. The artificial reef of claim 1, wherein a ratio of the representative amplitude of the plurality of waves to the equivalent diameter is between 0.1 and 0.5.

17. The artificial reef of claim 1, wherein the angular orientation of each of the peripheral components is between 1/6 and 11/6 radians.

18. A method for coastal protection and marine habitat, comprising:
providing the artificial reef of claim 1, wherein the equivalent diameter of the artificial reef is selected to achieve a predetermined ratio of wave amplitude to the equivalent diameter; and wherein the plurality of modules is constructed from a plurality of voxels arranged to create a predetermined porosity;
positioning each of the peripheral components at the x-distance along the first axis and the y-distance along the second axis from the central component; and
deploying the plurality of modules in a staggered arrangement at the selected location to dissipate wave energy while providing spaces for marine life.
